(19) United States
(12) Patent Application Publication
(10) Pub. No.: US 2004/0078724 A1
(43) Pub. Date: Apr. 22, 2004

(54) Event processing system

(76) Inventors: S. Brandon Keller, Evans, CO (US); Gregory Dennis Rogers, Fort Collins, CO (US); George Harold Robbert, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/180,044

(22) Filed: Jun. 26, 2002

(51) Int. Cl. G06F 11/00

(52) U.S. Cl. 714/48

(57) ABSTRACT

Techniques are disclosed for processing events, such as errors, in an event processing computer system. For example, an event processor may receive an indication of an event (such as an error), identify a priority of the event, and determine whether an action is associated with the priority of the event. If an action is associated with the priority of the event, the action may be performed. The action may, for example, include outputting a message associated with the event to an output location. A user of the system may specify which actions the event processor is to perform for events of various priorities. For example, the user may indicate that messages should only be output for events having specified priorities. The user may specify such actions, and other parameters of the event processor, using configuration information which is distinct from the event processor.

### BACKGROUND

1. Field of the Invention

The present invention relates to techniques for processing events in computer systems and, more particularly, to techniques for prioritizing messages associated with events in computer systems.

2. Related Art

Integrated circuits (ICs) are becoming increasingly large and complex, typically including millions of individual circuit elements such as transistors and logic gates. Very Large Scale Integrated (VLSI) Circuits are too large and complex for a circuit designer, or even a large team of circuit designers, to manage effectively on an element-by-element basis. As a result of this increased size and complexity, IC designers are increasingly using electronic design automation (EDA) software tools to assist with IC design. Such tools help to manage the complexity of the design task in a variety of ways, such as by allowing ICs to be designed hierarchically, thereby enabling the design to be divided into modules and enabling the design task to be divided among multiple designers in a manner that limits the complexity faced by any one designer.

Various hardware description languages (HDLs) have been developed which allow circuit designs to be described at various levels of abstraction. A description of a circuit according to an HDL (referred to herein as an “HDL model” of the circuit) may, for example, describe a particular circuit design in terms of the layout of its transistors and interconnects on an IC, or in terms of the logic gates in a digital system. Descriptions of a circuit at different levels of abstraction may be used for different purposes at various stages in the design process. HDL models may be used for testing circuits and circuit designs, as well as for fabricating the circuits themselves. The two most widely-used HDLs are Verilog and VHDL (Very High Speed Integrated Circuits (VHSIC) Hardware Description Language), both of which have been adopted as standards by the Institute of Electrical and Electronics Engineers (IEEE). VHDL became IEEE Standard 1076 in 1987 and Verilog became IEEE Standard 1364 in 1995.

EDA tools typically allow circuit designers to specify circuit designs using HDLs. Such tools may, for example, accept an HDL description of a circuit as an input and create, from the description, a hierarchical database representing the circuit design. The EDA tool may also display a graphical representation of the circuit design based on the HDL description. One example of such a tool for designing VLSI circuits is Virtuoso® Schematic Composer, available from Cadence Design Systems, Inc. of San Jose, Calif.

EDA tools may also allow the circuit designer to design circuits using a graphical user interface. The EDA tool may, for example, display a graphical 2D or 3D representation of the circuit design, in the form of a schematic diagram, on a display monitor. The circuit designer may use conventional input devices, such as a mouse and/or keyboard, to edit the design through the EDA tool's graphical user interface.

For example, referring to FIG. 1, a prior art circuit design system 100 is shown in which a human circuit designer 116 creates and modifies a model 102 of an integrated circuit design using a circuit design tool 104. The circuit designer 116 may, for example, use a keyboard 114 or other input device to provide input 108 to the circuit design tool 104, in response to which the circuit design tool 104 may modify the circuit model 102 and display a graphical representation 106 of the circuit model 102 (or of particular layers therein) on a display monitor 112.

The circuit model 102 may include, for example, information specifying the name, location, and size of each digital logic gate, signal trace, ground metal, via, and other elements of the circuit model 102. The circuit model 102 is typically stored in a database file in a computer system.

One example of the circuit design tool 104 is Virtuoso® Schematic Composer, available from Cadence Design Systems, Inc. of San Jose, Calif. Virtuoso® Schematic Composer is a software program which allows the circuit designer 116 to model the physical, electrical, and thermal characteristics of the circuit modeled by the circuit model 102. A Virtuoso® circuit design database (e.g., the circuit model 102) may be provided to a foundry to be used directly as manufacturing input for fabrication of the designed circuit.

The circuit design process can be tedious, time-consuming, and complex. In particular, analyzing the circuit model 102 to determine whether it satisfies various design constraints can be difficult to perform manually. Automated design analysis tools have been developed to automate the analysis of physical, electrical, and thermal characteristics of the circuit model 102 to provide the circuit designer 116 with feedback about such characteristics. For example, system 100 includes an analysis tool 118, which may analyze the circuit model 102 and provide the circuit designer 116 with information describing the results of the analysis. Examples of the analysis tool 118 include VoltageStorm™ SoC, available from Simplex Solutions, Inc. of Sunnyvale, Calif., as well as PathMill®, PathMill® Plus, and PowerMill®, all available from Synopsys, Inc. of Mountain View, Calif.

The analysis tool 118 transmits circuit model access commands 120 to the circuit design tool 104, in response to which the circuit design tool 104 transmits circuit model information 122 to the analysis tool 118. The circuit model information 122 contains information descriptive of the circuit model 102, such as the location and size of digital logic gates, signal traces, ground metal, and vias in the circuit model 102.

The analysis tool 118 may, for example, determine whether various characteristics of the circuit model 102 satisfy particular design rules and output one or more error messages 110 to the display monitor 112 if the design rules are not satisfied. In general, a design rule specifies a constraint that elements within the circuit model 102 must satisfy to ensure successful fabrication and operation of the circuit being modeled. Such constraints may include, for example, electrical, geometrical, or timing constraints. A design rule may, for example, specify a minimum distance between signals, or specify a maximum signal density. Conventional circuit design and analysis tools typically provide default design rules and means for specifying additional design rules to be applied to the circuit model 102. Conventional design and analysis tools also typically include automated Design Rule Checkers (DRCs), which automatically determine whether the active design rules are satisfied.

The analysis tool 118 may display a large number and wide variety of error messages 110 to the circuit designer 116 during and/or after the analysis. Error messages 110 may inform the circuit designer 116 of design rule violations and of other problems with the circuit model 102. Such error messages 110 may, for example, be displayed as lines of text in an error report file and/or as messages on the display monitor 112. Furthermore, the error messages 110 may include large numbers and various kinds of status messages which indicate the current state of the analysis.

Typically, the circuit designer 116 must manually sift through and interpret the error messages 110 to determine which of the error messages 110 are particularly important or otherwise deserving of attention. This can be a tedious, time-consuming, and error-prone process. As a result, the circuit designer 116 may fail to identify particularly important or relevant ones of the error messages 110 or may only identify such error messages after expending a significant amount of effort.

What is needed, therefore, are improved techniques for prioritizing messages associated with events in a computer system.

### SUMMARY

Techniques are disclosed for processing events, such as errors, in an event processing computer system. For example, an event processor may receive an indication of an event (such as an error), identify a priority of the event, and determine whether an action is associated with the priority of the event. If an action is associated with the priority of the event, the action may be performed. The action may, for example, include outputting a message associated with the event to an output location. A user of the system may specify which actions the event processor is to perform for events of various priorities. For example, the user may indicate that messages should only be output for events having specified priorities. The user may specify such actions, and other parameters of the event processor, using configuration information which is distinct from the event processor.

For example, in one aspect of the present invention, a computer-implemented method is provided including steps of: (A) receiving an indication of an error; (B) identifying a priority of the error; (C) determining whether an action is associated with the priority of the error; (D) identifying the action associated with the priority of the error if it is determined that an action is associated with the priority of the error; and (E) performing the action associated with the priority of the error if it is determined that an action is associated with the priority of the error. The method may, for example, identify a type of the error and identify the priority of the error based on the type of the error using, for example, a plurality of mappings between error types and error priorities. The method may determine whether an action is associated with the priority of the error based on a plurality of mappings between error priorities and actions. The method may also identify the action associated with the priority of the error based on the plurality of mappings between error priorities and actions.

The action may, for example, include outputting a message associated with the priority or type of the error to an output location associated with the priority or type of the error. The error indication may comprise a data structure including the type of the error and/or the message to output. The method may, for example, identify the output location based on the priority of the error using, for example, a plurality of mappings between error priorities and output locations.

The action may, for example, include limiting the number of times that other actions are taken in response to errors having the priority and/or type of the error. An error counter limit may, for example, be associated with each error priority/type, and the method may limit the number of times that actions are taking in response to errors of a particular priority/type to the maximum specified by the corresponding error counter limit.

The action may, for example, include a process termination action associated with the priority/type of the error. The method may, for example, terminate a process associated with the method if it is determined that the process termination action is associated with the priority/type of the error.

In another aspect of the present invention, a computer-implemented method is provided including steps of: (A) receiving an indication of an event associated with a message suitable for output to a user through an output device; (B) identifying a priority of the event; (C) determining whether the message should be output to the user through the output device based on the priority of the event; and (D) outputting the message to the user through the output device if it is determined that the message should be output to the user through the output device. The method may, for example, identify a type of the event and identify the priority of the event based on the type of the event using, for example, a plurality of mappings between event types and event priorities.

The event indication may comprise a data structure including the type of the event and/or the message to output. The method may, for example, identify the output location based on the priority of the event using, for example, a plurality of mappings between event priorities and output locations.

In yet another aspect of the present invention, a system is provided which includes a plurality of priority-action mappings between a plurality of event priorities and a plurality of event actions. The system also includes a software program including computer program instructions for: receiving an indication of an event associated with a message suitable for output to an output location; identifying a priority of the event; determining whether an action is associated with the event based on the plurality of priority-action mappings; identifying the action associated with the event if it is determined that an action is associated with the event; and performing the action associated with the event if it is determined that an action is associated with the event. The plurality of priority-action mappings may, for example, not comprise a part of the computer program instructions. The plurality of priority-action mappings may be provided as an input to the software program.

Other features and advantages of various aspects and embodiments of the present invention will become apparent from the following description and from the claims.

### BRIEF DESCRIPTION OF THE DRAWINGS

FIG. 1 is a functional block diagram of a prior art system for creating and editing a model of an integrated circuit;

FIG. 2A is a functional block diagram of a system for prioritizing errors related to an integrated circuit design according to one embodiment of the present invention;

FIG. 2B is a functional block diagram of a portion of a system for prioritizing errors that are provided to multiple circuit designers;

FIG. 3A is a block diagram of the logical structure of configuration information that is used to prioritize errors related to an integrated circuit design according to one embodiment of the present invention;

FIG. 3B is a block diagram of the logical structure of information maintained by an error processor according to one embodiment of the present invention;

FIG. 4A is a flow chart of a method for initializing an error processor in one embodiment of the present invention;

FIG. 4B is a flow chart of a method for processing errors related to an integrated circuit design according to one embodiment of the present invention; and

FIG. 5 is a block diagram of the logical structure of a sequence of errors generated by an integrated circuit design analysis tool according to one embodiment of the present invention.

### DETAILED DESCRIPTION

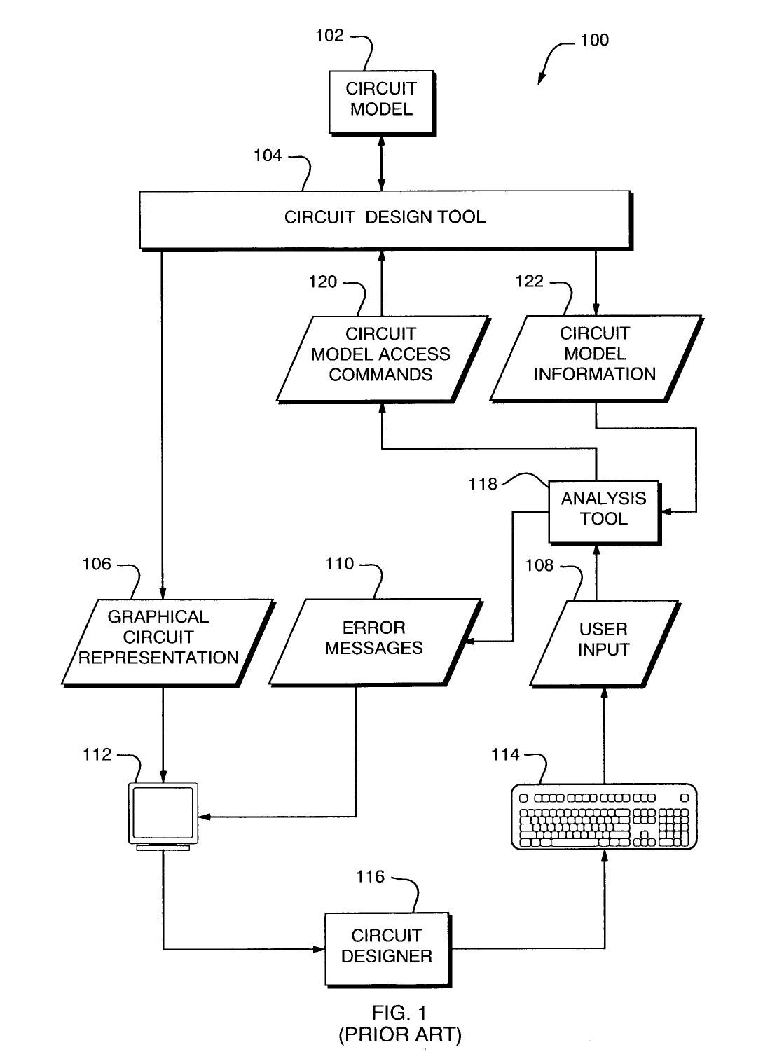

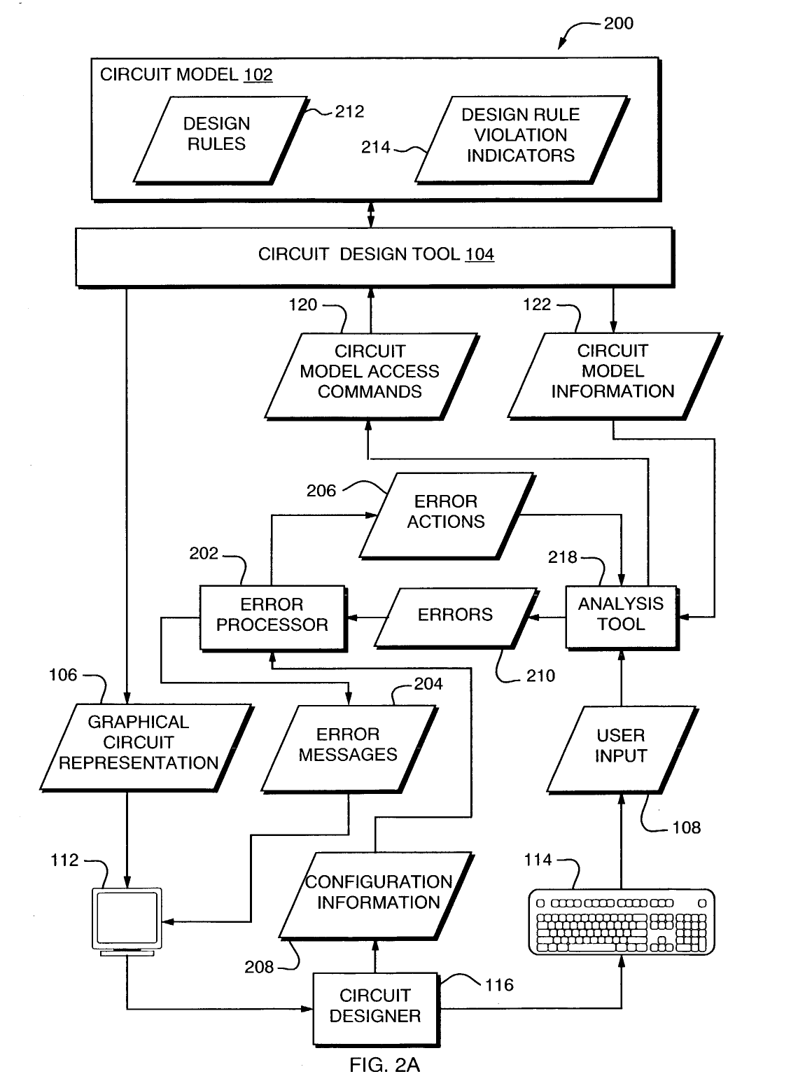

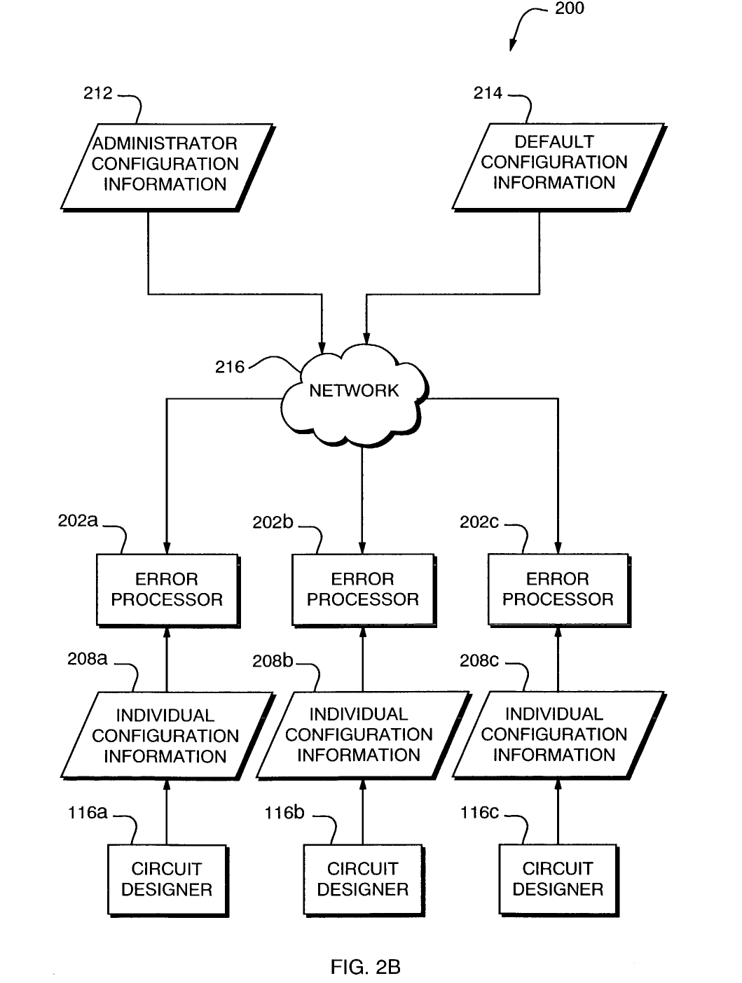

Referring to FIG. 2A, a functional block diagram is shown of a system 200 for prioritizing errors generated by a circuit design analysis tool 218 according to one embodiment of the present invention. The system 200 includes the circuit design tool 104 (such as Virtuoso® Schematic Composer), which the circuit designer 116 may use to create and modify the circuit model 102, as described above with respect to FIG. 1. The analysis tool 218 may, for example, be a conventional analysis tool (such as the analysis tool 118 shown in FIG. 1) or an analysis tool that has been customized to perform the functions described herein.

The system 200 also includes an error processor 202 for processing errors 210 generated by the analysis tool 218. In particular, the error processor 202 may prioritize the errors 210 generated by the analysis tool 218, perform actions 206 in response to some or all of the errors 210, and output error messages 204 in response to some or all of the errors 210 on the display monitor 112 and/or other output devices. The error processor 202 may process errors 210 as they are generated by the analysis tool 218. The error processor 202 and the analysis tool 218 may, for example, be implemented as a single software program or as distinct software programs which communicate with each other in any of various ways, as described in more detail below. The circuit designer 116 may configure the operations performed by the error processor 202 using configuration information 208.

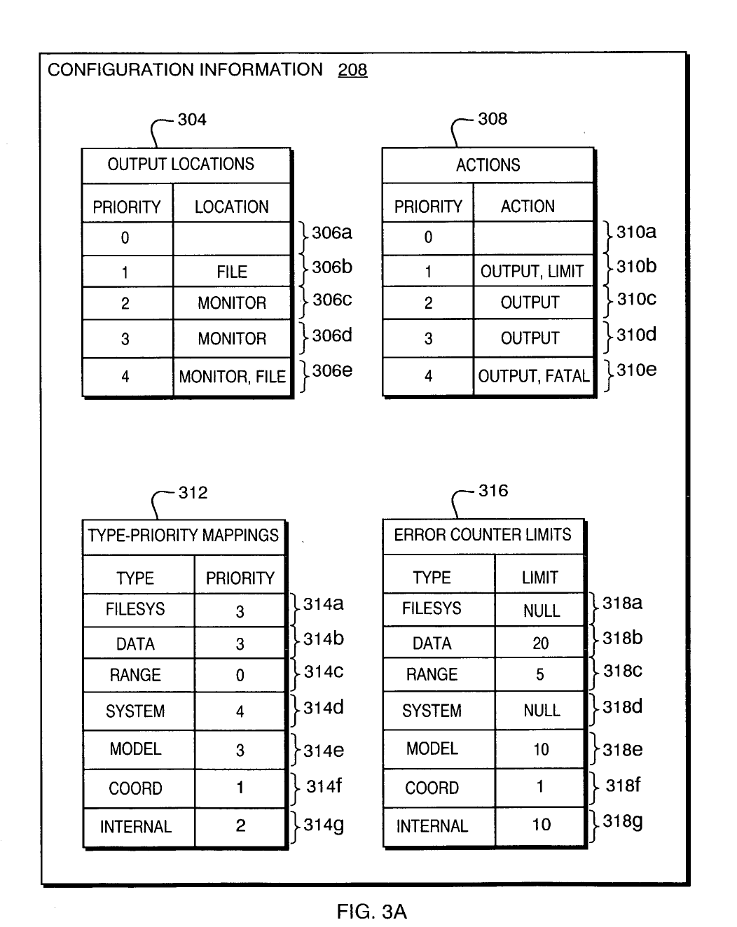

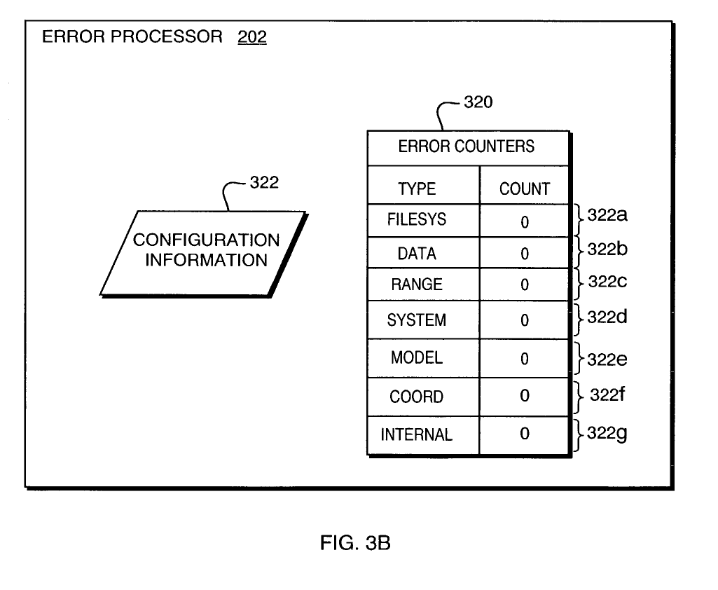

Operation of the system 200 according to various embodiments of the present invention will now be described in more detail. Referring to FIG. 3A, one embodiment of the configuration information 208 is illustrated. The circuit designer 116 may provide the configuration information 208 to the error processor 202, either directly (as shown in FIG. 2A) or indirectly through the analysis tool 218. The configuration information 208 provides the error processor 202 with various parameters of the error prioritization process performed by the error processor 202. The configuration information 208 may, for example, take the form of a command line with parameters, a configuration file stored on a hard disk drive, or commands issued to the error processor 202 using a graphical user interface. Provision of the configuration information 208 to the error processor 202 by the circuit designer 116 may therefore serve both to invoke the analysis tool 218 and to provide parameter values to the error processor 202 for use in error processing.

The errors 210 generated by the analysis tool 218 may be of various types. For example, in one embodiment of the present invention, there are seven error types. Each of the error types is denoted by a unique identifier in the configuration information 208 as follows:

(1) FILESYS, which refers to file system errors, such as errors opening, closing, reading from, or writing to files, such as files which comprise the circuit model 102;

(2) DATA, which refers to data errors, such as the occurrence of a null pointer where valid data in the circuit model 102 are expected;

(3) RANGE, which refers to data values in the circuit model 102 which are outside of their expected range (such as a resistance value which is abnormally high);

(4) SYSTEM, which refers to errors generated by the operating system on which the analysis tool 218 and the error processor 202 are executing, such as out-of-memory errors;

(5) MODEL, which refers to errors accessing the circuit model 102, such as a failure to find a specified block in the circuit model 102;

(6) COORD, which refers to errors coordinating the analysis tool 218 with other tools, such as the inability to successfully provide a parameter to another tool (not shown); and

(7) INTERNAL, which refers to internal errors generated by assertions within the analysis tool 218. (An “assertion” is a software instruction that triggers an error if a specified expression is false under the conditions in which it is evaluated.)

These particular error types are provided merely for purposes of example and do not constitute a limitation of the present invention. Furthermore, the use of explicit error types is provided merely for purposes of example and does not constitute a limitation of the present invention. Rather, as described in more detail below, errors may be assigned priorities directly without the use of explicit error types.

The configuration information 208 includes type-priority mappings 312 which map the error types to error priorities. More specifically, type-priority mappings 312 include individual type-priority mappings 314a-g, each of which maps one of the error types to a particular priority. In the present example, there are five priorities, numbered sequentially from zero through four, with zero being the lowest priority and four being the highest priority. For example, the RANGE error type has a priority of zero (mapping 314c), while the SYSTEM error type has a priority of four (mapping 314d). These particular priorities and type-priority mappings are provided merely for purposes of example and do not constitute limitations of the present invention.

The configuration information 208 also includes priority-action mappings 308 which map the error priorities to error actions. More specifically, priority-action mappings 308 include individual priority-action mappings 310a-e, each of which maps one of the error priorities to zero or more actions to be performed for messages having that priority. In the present example, there are three possible actions, labeled OUTPUT, LIMIT, and FATAL, which may be specified in any combination for a particular priority. The OUTPUT action indicates that an error message should be output to one or more output locations. The LIMIT action indicates that action should only be taken a limited number of times for errors having the corresponding priority. The FATAL action (referred to more generally herein as a “process termination action”) indicates that errors having the corresponding priority should be considered to be fatal errors, and that the analysis tool 218 should therefore be terminated when such an error is encountered.

Priority zero, for example, does not have a specified action (mapping 310a). This indicates that the error processor 202 will not take any action when it receives from the analysis tool 218 an error having priority zero. In particular, this means that the error processor 202 will not display error messages on the display monitor 112 or other output device for errors having priority zero. In the present example, only errors of type RANGE have a priority of zero (mapping 314c).

Priority one, for example, is associated with two actions: OUTPUT and LIMIT (mapping 310b). This means that error messages will be output on the display monitor 112 and/or other output device(s) for errors having priority one, but that such error messages will only be output a limited number of times. In the present example, only errors of type COORD have a priority of one (mapping 314f).

Priorities two and three, for example, are associated with the action OUTPUT (mappings 310c and 310d, respectively). This means that error messages will be output on the display monitor 112 and/or other output device(s) for errors having priorities two and three for an unlimited number of times. In the present example, errors of type INTERNAL have a priority of two (mapping 314g), while errors of type FILESYS, DATA, and MODEL have priorities of three (mappings 314a, 314b, and 314e, respectively).

Priority four, for example, is associated with two actions: OUTPUT and FATAL (mapping 310e). This means that when the error processor 202 encounters an error having priority four, the error processor 202 will output an error message for the error and then terminate the operation of the analysis tool 218. As a result, in practice the analysis tool 218 and the error processor 202 will terminate after the first error having priority four is encountered.

The configuration information 208 also includes priority-location mappings 304 which map error priorities to output locations. More specifically, priority-location mappings 304 include individual priority-location mappings 306a-e, each of which maps one of the error priorities to zero or more output locations. In the present example, there are two allowable output locations, FILE (which indicates that the corresponding error message should be written to a predetermined file on disk) and MONITOR (which indicates that the corresponding error message should be displayed on the display monitor 112). The error processor 202 may create an error log file to contain error messages output to the FILE output location. These particular output locations are provided merely for purposes of example and do not constitute limitations of the present invention.

For example, in the present embodiment, priority zero does not map to any output location (mapping 306a), indicating that error messages for errors having priority zero should not be output to any output location. Priority one maps to the FILE output location (mapping 306b) and priorities two and three map to the MONITOR output location (mappings 306c and 306d, respectively). Priority four maps both to the MONITOR and the FILE output locations (mapping 306e), indicating that error messages for errors having priority four should both be written to a file and be displayed on the display monitor 112.

The configuration information 208 also includes error counter limits 316 which specify the maximum number of times that error messages for errors of each type should be output. More specifically, error counter limits 316 include individual type-limit mappings 318a-g, each of which maps one of the error types to an error counter limit. In the present example, an error counter limit may either be a positive integral value, indicating the maximum number of times to output an error message for errors of the corresponding type, or the value NULL (such as −1), indicating that there is no limit to the number of times that error messages for errors of the corresponding type should be output.

For example, in the present embodiment, error messages of type FILESYS and SYSTEM may be output an unlimited number of times (mappings 318a and 318d, respectively). Error limits for error type DATA (20), RANGE (5), MODEL (10), COORD (1), and INTERNAL (10), are provided by mappings 318b, 318c, 318e, 318f, and 318g, respectively. The particular type-limit mappings 318a-g shown in FIG. 3A are provided merely for purposes of example and do not constitute limitations of the present invention.

In the embodiment of the configuration information 208 illustrated in FIG. 3A, both error types and error priorities are employed. This is not, however, a limitation of the present invention. The techniques described herein may, for example, alternatively be implemented with the use of error types but not error priorities, or with the use of error priorities but not error types. In either such case, the configuration information 208 may not include the type-priority mappings 312. If only error types are used, then the priority-location mappings 304 may alternatively be implemented as type-location mappings, and the priority-action mappings may alternatively be implemented as type-action mappings. Similarly, if only error priorities are used, then the type-limit mappings 316 may be implemented as priority-limit mappings.

Furthermore, even in cases when both error types and error priorities are employed, the priority-location mappings 304 may alternatively be implemented as type-location mappings, the priority-action mappings 308 may alternatively be implemented as type-action mappings, and the type-limit mappings 316 may alternatively be implemented as priority-limit mappings, in any combination.

The error processor 202 may, for example, receive the configuration information 208 from the circuit designer 116 and store the configuration information 208 for use in the processes described below. For example, referring to FIG. 3B, data structures which are maintained by the error processor 202 are shown according to one embodiment of the present invention. As shown in FIG. 3B, the error processor 202 includes configuration information 322, which may contain the same information as the configuration information 208. The configuration information 322 contained within the error processor 202 may be implemented, for example, as one or more data structures in the memory of a computer defined according to an appropriate programming language. The configuration information 208 that is provided by the circuit designer 116 may therefore undergo some amount of processing prior to being stored in the error processor 202 as configuration information 322.

The error processor 202 may also maintain error counters 320 for each of the error types. More specifically, the error counters 320 include individual error counters 322a-g, one for each of the error types. Each of the error counters 322a-g is illustrated in FIG. 3B as having an initial value of zero.

Referring to FIG. 2B, in another embodiment, the system 200 includes multiple circuit designers 116a-c and multiple error processors 202a-c. Each of the error processors 202a-c may, for example, reside and/or execute on a local workstation of the corresponding one of the circuit designers 116a-c. The circuit designers 116a-c may therefore execute the error processors 202a-c in parallel as they design and/or analyze different parts of the circuit model 102. Circuit designers 116a-c may provide individual configuration information 208a-c to corresponding ones of the error processors 202a-c. Each of the circuit designers 116a-c may tailor his individual configuration information to suit his particular needs at the time. For example, different circuit designers 116a-c may prioritize the error types differently (using the type-priority mappings 312), specify different actions to be performed (using the priority-action mappings 308), specify different output locations for error messages (using the priority-location mappings 304), and/or specify different error counter limits (using the error counter limits 316). Each of the error processors 202a-c may operate independently of the others, based on the individual configuration information that is provided to it by the corresponding circuit designer.

Furthermore, the error processors 202a-c may operate in a networked environment. For example, computers (not shown) on which the error processors 202a-c execute may communicate with each other and with other computers (not shown) over a network 216, which may be any kind of computer network. Default configuration information 214 may have the same data structure as the configuration information 208 illustrated in FIG. 3A and provide default values to be used by the error processors 202a-c in the absence of overriding values provided by the circuit designers 116a-c.

Furthermore, a system administrator, group leader, or other person may provide administrator configuration information 212, which may have the same data structure as the configuration information 208 illustrated in FIG. 3A, and which may provide configuration values which override the values in the default configuration information 214 and which may not be overridden by values in the individual configuration information 208a-c.

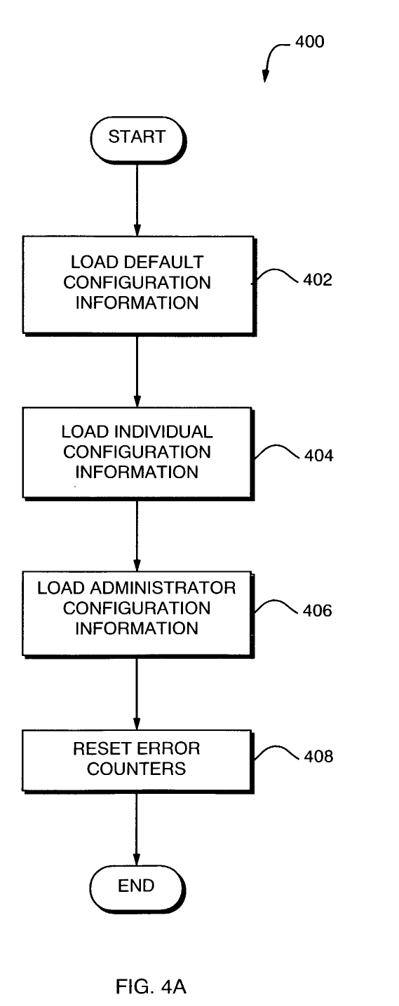

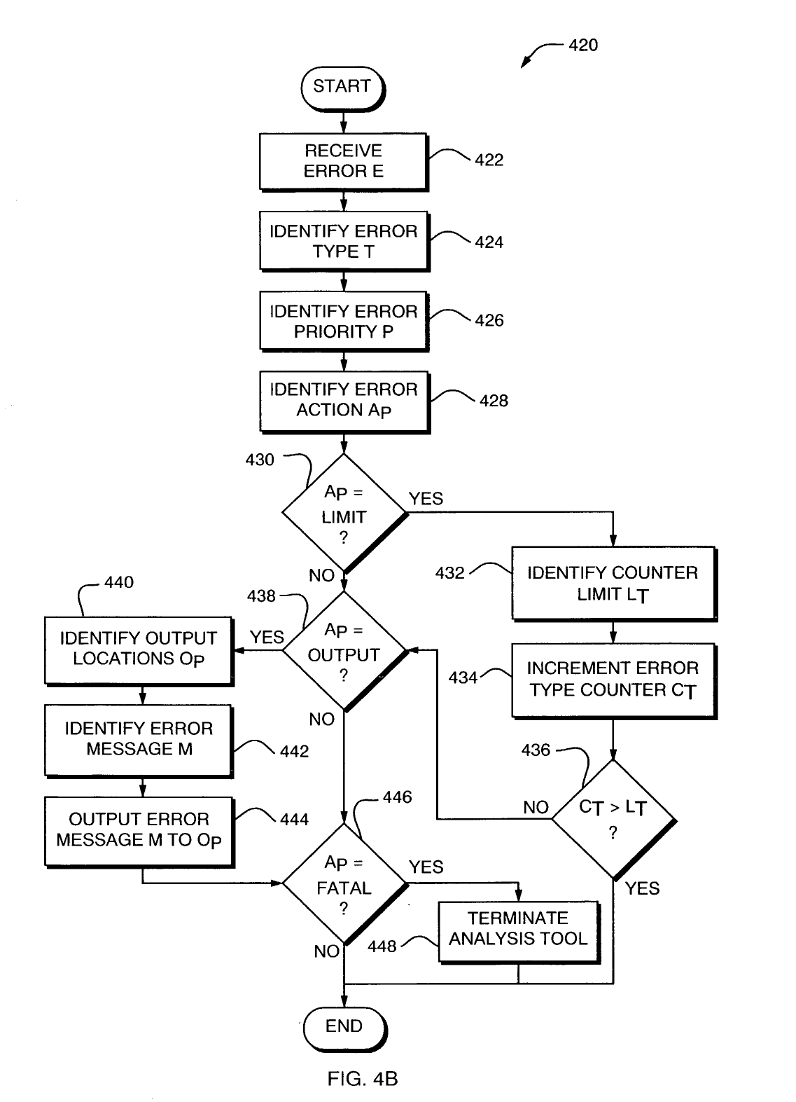

For example, referring to FIG. 4A, a flow chart of a method 400 is shown that may be executed by the error processors 202a-c prior to performing error processing (described below with respect to FIG. 4B). The method 400 may, for example, be performed when the analysis tool 218 begins to perform its analysis of the circuit model 102. For purposes of example, assume that the error processor 202a (FIG. 2B) is the error processor 202 (FIG. 2A). The error processor 202 loads the default configuration information 214 and copies the values that it provides into the configuration information 322 within the error processor 202 (step 402). The error processor 202 may, for example, read the default configuration information 214 over the network 216 and copy the values that it contains into the configuration information 322 within the error processor 202.

The method 400 loads the individual configuration information 208a and copies the values that it provides into the configuration information 322 within the error processor 202 (step 404). The configuration information 202a may, for example, provide values for fewer than all of the parameters illustrated in FIG. 3A. The circuit designer 116a may, therefore, only provide values for parameters in the individual configuration information 208a that he desires to be used to override the default values provided in the default configuration information 214. When the error processor 202a copies the individual configuration information 208a into the configuration information 322 within the error processor 202, any corresponding default values provided by the default configuration information 214 will be overridden.

The method 400 loads the administrator configuration information 212 and copies the values that it provides into the configuration information 322 within the error processor 202 (step 406). Any values provided by the administrator configuration information 212 will therefore override any values provided by either the default configuration information 214 or the individual configuration information 208a. As a result, the individual configuration information 208a provided by the circuit designer 116a may not be used to override the administrator configuration information 212.

Upon the completion of step 406, initialization of the configuration information 322 within the error processor 202 is complete. The method 400 resets the error counters 320 by setting their values to zero (step 408), as illustrated in FIG. 3B.

The administrator configuration information 212 and/or the default configuration information 214 need not be provided over the network 216. Rather, the administrator configuration information 212 and/or the default configuration information 214 may be incorporated into one or more of the error processors 202a-c, or be provided locally (i.e., on the same workstations as the error processors 202a-c).

Referring to FIG. 4B, a flowchart is shown of an error prioritization method 420 that is used by the error processor 202 to prioritize the errors 210 provided by the analysis tool 218 and to perform error actions 206 in response to the errors 210. The method 420 may, for example, be integrated into the analysis tool 218 so that the method 420 is performed each time the analysis tool 218 generates one of the errors 210. Alternatively, for example, the analysis tool 218 may transmit an indication to the error processor 202 that an error has been generated, thereby initiating the execution of method 420. Such an indication may, for example, be implemented as a function call or method invocation in any of a variety of programming languages. Alternatively, for example, such an indication may be implemented by transmitting a file or other message containing the error to the error processor 202.

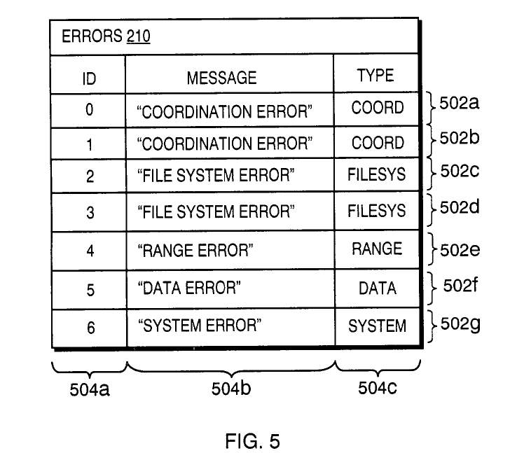

Assume for purposes of example that the initialization method 400 (FIG. 4A) has been completed prior to the execution of method 420. The method 420 receives an indication of an error E generated by the analysis tool 218 (step 422). The error indication may, for example, be implemented as an object in an object-oriented programming language or some other data structure. The method 420 identifies the type T of the error (step 424). For example, referring to FIG. 5, an example of the errors 210 is shown in which the errors 210 includes a stream of seven errors 502a-g. Assume for purposes of example that the errors 502a-g are generated by the analysis tool 218 in the order illustrated. Each of the errors 502a-c includes an ID field 504a, a message field 504b, and a type field 504c. Application of the method 420 to the particular errors 502a-g will be described in more detail below.

The error E received by the method 420 (step 422) may, for example, have the data structure illustrated in FIG. 5. In step 424 the method 420 may, for example, identify the type T of the error by obtaining the type T from the type field 504c of the error.

The method 420 identifies the priority P of error E (step 426). The method 420 may identify the priority P, for example, by looking up the priority that corresponds to the type T in the type-priority mappings 312 (FIG. 3A).

The method 420 identifies the error action A_{P} corresponding to priority P (step 428). The method 420 may identify the error action A_{P} by, for example, looking up the error action that corresponds to the priority P in the priority-action mappings 308 (FIG. 3A). If, as described above, the priority-action mappings 308 are alternatively implemented as type-action mappings, the method 420 may identify the error action based on the type T rather than the priority P.

The method 420 determines whether the error action A_{P} includes the action LIMIT (step 430). Note that the error action A_{P} may include multiple actions. The step 430 therefore determines whether any of the actions within error action A_{P} is the LIMIT action. If the error action A_{P} does include the action LIMIT, indicating that the error action A_{P} should only be performed a limited number of times, the method 420 identifies the limit L_{T} that corresponds to the type T (step 432). The method 420 may identify the counter limit L_{T} by, for example, looking up the counter limit that corresponds to the type T in the type-limit mappings 318a-g.

The method 420 increments the error type counter C_{T} (FIG. 3B) corresponding to type T (step 434). If the counter C_{T} is greater than the counter limit L_{T} (step 436), then the method 420 ends. As a result, the method 420 will neither perform any other action in response to the error E nor output an error message in response to the error E.

If the error action A_{P} does not include the LIMIT action (step 430), or the error action A_{P} includes the LIMIT action but the counter C_{T} is not greater than the counter limit L_{T} (step 436), the method 420 determines whether the error action A_{P} includes the OUTPUT action (step 438). If the error action A_{P} does include the OUTPUT action, the method 420 identifies the output location(s) op corresponding to the priority P (step 440). The method 420 may identify the output location(s) O_{P} by, for example, looking O_{P} the output location(s) that corresponds to the priority P in the priority-location mappings 304.

The method 420 identifies an error message M associated with error message E (step 442). The method 420 may, for example, identify the error message M using the message field 504b of the error E (FIG. 5). The method 420 outputs the error message M to the output location(s) O_{P} (step 444). Note that step 444 may include outputting the error message M to multiple output locations. If the output location O_{P} does not specify any output locations, the step 444 will not output an error message to any output location.

The method 420 determines whether the error action A_{P} includes the FATAL action (step 446). If the error action A_{P} includes the FATAL action, the method 420 terminates the analysis tool 218 (step 448). As a result, the analysis tool 218 will not perform any additional analysis of the circuit model 102 and will not generate any additional errors 210, at least until the circuit designer 116 executes the analysis tool 218 again. If, for example, the error processor 202 and the analysis tool 218 are implemented in the same software program, the error processor 202 may terminate the analysis tool 218 by making an appropriate function call. If, for example, the error processor 202 and the analysis tool 218 are implemented as distinct software programs, the error processor 202 may terminate the analysis tool 218 by transmitting a “terminate” message to the analysis tool 218.

An example of the operation of the method 420 (FIG. 4B) will now be described with respect to the example errors 502a-g illustrated in FIG. 5. The identifiers 504a of errors 502a-g are numbered sequentially beginning with zero for purposes of example. More generally, any kind of unique identifier may be used for each of the identifiers 504a. For purposes of the present example, assume that error 502a is the first error generated by the analysis tool 218, error 502b is the second error generated by the analysis tool 218, and so on, so that the errors 502a-g comprise an error stream generated by the analysis tool 218.

Referring to FIG. 4B, the method 420 receives the first error 502a (step 422) and identifies the type T of the error 502a (step 424). In this case, the error type is COORD; as indicated in the type field 504c. The method 420 identifies the error priority P (step 426), which in this case is one, as indicated by type-priority mapping 314f (FIG. 3A). The method 420 identifies the error action A_{P} (step 428), which in this case includes the actions OUTPUT and LIMIT, as indicated by priority-action mapping 310b (FIG. 3A).

Because the error action A_{P} includes the action LIMIT (step 430), the method 420 identifies the counter limit L_{T} associated with error type COORD (step 432). In this case the counter limit L_{T} is one, as indicated by error counter limit 318f (FIG. 3A). Assume for purposes of example that the error counter 322f (FIG. 3B) for type COORD has been initialized to zero by method 400 (FIG. 4A). The method 420 increments the error type counter 322f for type COORD (step 434). As a result, the value of error type counter 322f is one upon completion of step 434.

The method 420 determines whether the error type counter 322f (C_{T}) is greater than the error counter limit 318f (L_{T}) (step 436). Because the error type counter 322f (which is equal to one) is not greater than the error counter limit 318f (which is also equal to one), the method 420 determines whether the error action A_{P} includes the action OUTPUT (step 438). Because the error action A_{P} includes the action OUTPUT, the method 420 identifies the output location(s) O_{P} associated with error priority one (step 440). As indicated by priority-location mapping 306b (FIG. 3A), the output location for error priority one is FILE.

The method 420 identifies the error message M associated with error message E (step 442). The method 420 outputs the error message associated with error E (in this case, the message “Coordination error”) to a file (step 444). The error processor 202 may, for example, be hard-coded with the name of a file in which to output error messages. Alternatively, for example, the circuit designer 116 may provide a file name in the configuration information 208.

The error messages 504b shown in FIG. 5 are generic and are provided merely for purposes of example. The analysis tool 218 may, for example, provide more detailed error messages for each of the errors 502a-g which describe more specifically the nature of the particular error. Alternatively, for example, the message field 504b may be omitted from the errors 502a-g, in which case the error processor 202 or the configuration information 208 may include a mapping between error types and error messages. In such a case, the error processor 202 may identify the error message in step 444 using the error type-message mapping.

The method 420 determines whether the error action A_{P} includes the action FATAL (step 446). Because the error action A_{P} in this case does not include the action FATAL, the method 420 ends.

When the method 420 receives the next error 502b (step 422), the method 420 identifies the error type of COORD (step 424), the error priority of one (step 426), and the error actions of OUTPUT and LIMIT (step 428) as described above. The method 420 determines that the error action A_{P} includes the action LIMIT (step 430) and therefore identifies the error counter limit L_{T} of one (step 432) and increments the error type counter C_{T} to a value of two (step 434). This time, however, the method 420 determines that the error type counter C_{T} is greater than the counter limit L_{T} (step 436). The method 420 therefore ends without outputting the error message associated with error 502b or taking any other action. Similarly, the method 420 will not output error messages or take any other action for any subsequent errors of type COORD that it encounters because the maximum number of errors of type COORD have already been processed. In this way, the method 420 limits the number of error messages that will be output to the circuit designer 116 for errors of type COORD using the error counter limit 318f specified by the circuit designer 116 in the configuration information 208.

The next error received by the method 420 (step 422) is the error 502c, which is of type FILESYS (step 424). The method 420 identifies the priority (3) of error 502c using type-priority mapping 314a (step 426) and the error action A_{P} (OUTPUT) of error 502c using the priority-action mapping 310d (step 428). Because the error action A_{P} does not include the action LIMIT (step 430), the method 420 does not increment the error type counter C_{T} for error type FILESYS. Therefore, the method 420 will perform the error action A_{P} (OUTPUT) for an unlimited number of errors of type FILESYS. The method 420 determines that the error action A_{P} includes the error action OUTPUT (step 438), and therefore: (1) identifies the output location O_{P} of MONITOR using the priority-location mapping 306d (step 440); (2) identifies the error message M (“File system error”) associated with error message E (step 442); and (3) outputs the error message M to the display monitor 112 (step 444). The method 420 determines that the error action A_{P} does not include the action FATAL (step 446) and therefore ends. The method 420 processes the next error 502d, which is also of type FILESYS, in the same way that it processes error 502c.

The next error received by the method 420 (step 422) is the error 502e, which is of type RANGE (step 424). The method 420 identifies the priority (0) of error 502e using type-priority mapping 314c (step 426) and the error action A_{P} (none) of error 502e using the priority-action mapping 310a (step 428). Because the error action A_{P} does not include the action LIMIT (step 430), the method 420 does not increment the error type counter C_{T} for error type RANGE. The method 420 determines that the error action A_{P} does not include the error action OUTPUT (step 438), and therefore does not output an error message corresponding to error 502e to any output location. The method 420 determines that the error action A_{P} does not include the action FATAL (step 446) and therefore ends. In summary, the method 420 neither outputs a message for error 502e nor takes any other action in response to error 502e. The circuit designer 116 therefore need not examine or sift through error messages related to errors of type RANGE, which the circuit designer 116 has designated to be of very low priority.

The next error received by the method 420 (step 422) is the error 502f, which is of type DATA (step 424). The method 420 identifies the priority (3) of error 502e using type-priority mapping 314b (step 426). The method 420 will process the error 502f in the same manner as it processed errors 502c-d, described above, because messages 502c, 502d, and 502f all have the same priority. The use of a relatively small number of priorities therefore allows the circuit designer 116 to specify the actions to take in response to a wide variety of error types using a relatively small amount of configuration information 208 by grouping the error types into error types having common priorities, and specifying output locations and error actions based on the relatively small number of priorities rather than the relatively large number of error types.

The next error received by the method 420 (step 422) is the error 502g, which is of type SYSTEM (step 424). The method 420 identifies the priority (4) of error 502g using type-priority mapping 314d (step 426) and the error actions A_{P} (OUTPUT and FATAL) of error 502g using the priority-action mapping 310e (step 428). Because the error action A_{P} does not include the action LIMIT (step 430), the method 420 does not increment the error type counter C_{T} for error type SYSTEM. The method 420 determines that the error action A_{P} includes the error action OUTPUT (step 438), and therefore outputs the error message M (“System error”) corresponding to error 502g to both the display monitor 112 and the error log file (steps 440-444). The method 420 determines that the error action A_{P} includes the action FATAL (step 446) and therefore terminates execution of the analysis tool 218 (step 448). The analysis tool 218 therefore stops performing its analysis of the circuit model 102 and does not generate any additional errors 210. The circuit designer 116 will typically designate only particularly serious errors as FATAL.

As described above with respect to FIG. 5, each of the errors 502a-g may have a unique identifier 504a. The identifiers 504a may be used to further customize error processing. For example, in the examples provided above, errors are processed based on their type and/or priority. The manner in which a particular error is processed, however, may further be determined based on the error's identifier.

The error processor 202 may, for example, suppress the performance of error actions for errors having particular identifiers. The circuit designer 116 may, for example, specify particular identifiers for which error messages should be suppressed. The circuit designer 116 may, for example, specify one or more numerical ranges of identifiers for which error messages should be suppressed. Such message identifiers may be provided in the configuration information 208.

Assume, for example, that the configuration information 208 specifies a range of identifiers for which messages should be suppressed. In such a case, when the error processor 202 receives an error E (FIG. 4B, step 422), the error processor 202 may identify the error's identifier and determine whether the configuration information 208 specifies that the identifier is one for which messages are to be suppressed. If the identifier is determined to be one for which messages are to be suppressed, the error processor 202 may not output a message for the error E, even if the error action A_{P} associated with error E's priority P includes the OUTPUT action. In this way, the circuit designer 116 may specify identifier-based exceptions to the normal priority-based generation of messages. Similar techniques may be used to suppress the performance of any error action (such as the LIMIT and FATAL actions) or combination of error actions on the basis of error identifier.

Similar techniques may be used to enable the output of messages for errors having particular identifiers. The circuit designer 116 may, for example, specify (in the configuration information 208) particular identifiers for which messages should be enabled. When the error processor 202 receives an error E (FIG. 4B, step 422), the error processor 202 may identify the error's identifier and determine whether the configuration information 208 specifies that the identifier is one for which messages are enabled. If the identifier is determined to be one for which messages are enabled, the error processor 202 may output a message for the error E, even if the error action A_{P} associated with error E's priority P does not include the OUTPUT action. In this way, the circuit designer 116 may specify identifier-based exceptions to the normal priority-based suppression of messages for errors. Similar techniques may be used to enable the performance of any error action (such as the LIMIT and FATAL actions) or combination of error actions on the basis of error identifier.

The circuit designer 116 may specify that errors having particular identifiers be assigned a priority (referred to herein as an “override priority”) that differs from the errors' default priority (i.e., the priority specified by the type-priority mappings 312). The circuit designer 116 may, for example, provide (within the configuration information 208) mappings between particular error identifiers and corresponding override priorities. In such an embodiment, the error processor 202 may identify the error priority P of error E (FIG. 4B, step 426) by: (1) determining whether an override priority has been specified for error E's identifier; (2) identifying the override priority as the error's priority P if such an override priority has been specified; and (3) otherwise, identifying the priority P based on the type-priority mappings 312, as described above with respect to step 426. One use of such override priorities is to make an error that would otherwise be treated as an informational or warning error into a fatal error by changing the error's priority to a priority (such as priority 4 in the examples above) associated with the FATAL error action.

Similarly, the circuit designer 116 may limit the number of times that messages are output for errors having particular identifiers. The circuit designer 116 may, for example, provide (within the configuration information 208) mappings between particular error identifiers and error counter limits. The error processor 202 may limit the number of error messages that are output for error messages having particular identifiers in the same way that the error processor 202 limits the number of times that error messages are output for errors having particular priorities, as described above with respect to FIG. 4B, steps 430-436.

The analysis tool 218 makes use of various data from the circuit model 102, such as the names and coordinates of signal traces, to perform its analysis and to determine whether to generate errors 210. Various techniques that may be used by the analysis tool 218 to access and process such data will now be described in more detail. Statements made below about the analysis tool 218 are equally applicable to the error processor 202.

The analysis tool 218 may access information in the circuit model 102 by transmitting circuit model access commands 120 to the circuit design tool 104. The circuit model access commands 120 may take any of a variety of forms. For example, the circuit design tool 104 may provide an application program interface (API) through which external software programs may access information contained in the circuit model 102 using commands defined according to the API. The analysis tool 218 may be implemented as such an external software program, and the circuit model access commands 120 may be implemented as commands defined according to the circuit design tool's API. The API may include both commands for reading information from the circuit model 102 and commands for writing information to the circuit model 102. In such an implementation, the analysis tool 218 transmits circuit model access commands 120 to the circuit design tool 104, in response to which the circuit design tool 104 either modifies information in the circuit model 102 or transmits the requested information about the circuit model 102 to the analysis tool 218 in the form of circuit model information 122.

The circuit model information 122 may, for example, be a report in the form of a text file including information such as the names, locations, and sizes (e.g., lengths or diameters) of digital logic gates, signal traces, ground metal, vias, and other elements of the circuit model 102. The analysis tool 218 may process the information in such a report to perform the functions described herein using techniques that are well-known to those of ordinary skill in the art.

The analysis tool 218 and/or the error processor 202 may be implemented as a software program that executes within the design environment provided by the circuit design tool 104. For example, the Virtuoso® Schematic Composer circuit design tool described above allows scripts written in the Skill scripting language to be executed within the Virtuoso® design environment, e.g., while the circuit designer 116 is using the circuit design tool 104 to design the circuit model 102. The error processor 202 may be implemented as a Skill script, in which case the circuit model access commands 120 may be Skill commands issued by the error processor 202 to the circuit design tool 104.

Referring again to FIG. 2A, the circuit model 102 may include design rules 212 which specify constraints that elements within the circuit model 102 must satisfy to ensure successful fabrication and operation of the circuit being modeled. Such constraints may include, for example, electrical, geometrical, or timing constraints. A design rule may, for example, specify a minimum distance between signal traces in a layer, or specify a maximum signal trace density in a layer. Conventional circuit design tools, such as Virtuoso® Schematic Composer, typically provide default design rules and means for specifying additional design rules to be applied to a circuit model. Conventional circuit design tools also typically include automated Design Rule Checkers (DRCs), which automatically determine whether the active design rules are satisfied, and which use design rule violation indicators 214 to alert the circuit designer 116 to any design rules which are violated by the circuit model 102. The design rule violation indicators 214 may, for example, be visual indicators (such as a red flag) displayed at the location of the violation within the graphical circuit representation 106 that is displayed to the circuit designer 116.

Rather than providing the circuit designer 116 with external error messages 204 to indicate the presence of errors 210, the error processor 202 may use circuit model access commands 120 to insert design rule violation indicators 214 into the circuit model 102. Such design rule violation indicators 214 notify the circuit designer 116 of errors 210 and therefore play the same role as error messages 204. For example, referring again to FIG. 4B, step 444 (outputting the error message to output location O_{P}) may be implemented by adding a design rule violation indicator to the circuit model 102. The design rule violation indicator thus provided may indicate the location (e.g., the particular circuit element) at which the design rule violation was identified. Techniques for adding design rule violation indicators to circuit models maintained by conventional circuit design tools are well-known to those of ordinary skill in the art.

Some circuit design tools provide “real-time” design rule checking, according to which the design rule violation indicators 214 are provided (e.g., displayed) to the circuit designer 116 as the circuit designer 116 designs the circuit model 102. For example, the circuit designer 116 may place a new circuit element in the circuit model 102 by using a mouse to drag a graphical representation of the circuit element to an appropriate location within the graphical representation 106 (e.g., schematic) of the circuit model 102. The circuit design tool 104 may visually indicate to the circuit designer 116 in real-time whether the new circuit element is too close to existing circuit elements or violates some other design rule, such as by displaying a red flag on the monitor 112 when the designer 116 drags the new circuit element too close to an existing circuit element.

The error processor 202 may, for example, be implemented as a real-time design rule. In such an implementation, the circuit design tool 104 may verify in real-time that design rules are satisfied for the circuit element being edited by the circuit designer 116, and provide appropriate design rule violation indicators 214 when any such rules are violated.

Among the advantages of the invention are one or more of the following.

The techniques herein automatically prioritize the errors 210 that are generated by the analysis tool 218. In particular, the error processor 202 automatically filters out errors having low priorities and only displays to the circuit designer 116 error messages corresponding to errors having high priorities. As described above, the analysis tool 218 may generate hundreds or thousands of errors 210 during the course of its analysis. The automatic prioritization and filtration provided by the error processor 202 simplifies the task of identifying relevant error messages generated during the analysis process. The total number of error messages 204 generated by the error processor 202 may be sufficiently small to be analyzed and interpreted by the circuit designer 116 manually in a relatively small amount of time.

Another advantage of the techniques disclosed herein is that they allow the circuit designer 116 to customize various aspects of the methods performed by the error processor 202 using the configuration information 208. For example, separating the variable aspects of the prioritization process out of the error processor 202 and into the configuration information 208, which may be modified by the circuit designer 116, allows the circuit designer 116 to flexibly customize the operation of the error processor 202 simply by modifying the configuration information 208. For example, the circuit designer 116 may modify the priorities that are assigned to errors of different types, the actions that are taken in response to errors of different priorities/types, and the output locations to which error messages of different priorities/types are output by modifying the configuration information 208. The circuit designer 116 may, for example, modify the configuration information 208 depending on the particular kinds of errors which are of interest at a particular point in time.

Furthermore, the configuration information 208 may be modified without modifying the error processor 202 itself. As described above, the error processor 202 may be implemented as a software program and the configuration information 208 may, for example, be implemented as a text file. The circuit designer 116 may therefore modify the configuration information 208 simply by modifying a text file and without re-coding and/or re-compiling the error processor 202. In most cases, therefore, it will be quicker and easier to modify the configuration information 208 than to modify the error processor 202 itself. Furthermore, the circuit designer 116 may modify the operation of the error processor 202 without having any programming knowledge.

Furthermore, as described above with respect to FIG. 2B, different circuit designers 116a-c may use different configuration information 208a-c. The individual circuit designers 116a-c are therefore not limited to using a fixed set of error priorities established by the designer of the error processor 202 or by a system administrator. This provides an additional degree of flexibility, particularly since the different configuration information 208a-c may be used with the same error processor software.

The error prioritization system 200, however, allows a system administrator or other person to override the priorities established by the individual circuit designers 116a-c using the administrator configuration information 212. Use of the administrator configuration information 212 therefore strikes a balance between providing individualized and centralized control over the parameters of the error prioritization process.

Furthermore, the use of the default configuration information 214 allows the system administrator or other person to provide default parameter values for use by the error processor 202. As a result, the individual circuit designers 116a-c need not specify values for all parameters of the error prioritization process. This may reduce the time and effort necessary to create the individual configuration information 208a-c, because the circuit designers 116a-c need only provide parameter values that differ from those provided by the default configuration information 214.

All of the advantages described herein contribute to the likelihood that error messages 204 that are provided to the circuit designer 116 will be relevant to the circuit designer 116 and that irrelevant error messages will be absent from the error messages 204, thereby making the circuit designer's work easier and more efficient.

It is to be understood that although the invention has been described above in terms of particular embodiments, the foregoing embodiments are provided as illustrative only, and do not limit or define the scope of the invention. Various other embodiments, including but not limited to the following, are also within the scope of the claims.

As described above with respect to FIG. 4B, the error processor 202 may prioritize errors 210, perform actions 206 in response to some or all of the errors 210, and output error messages 204 in response to some or all of the errors 210. The particular method 420 illustrated in FIG. 4B is provided merely for purposes of example and does not constitute a limitation of the present invention. The error processor 202 may, for example, prioritize errors 210 and output error messages 204 in response to some or all of the errors 210, but not perform any actions 206 in response to the errors 210. Furthermore, although the method 420 described above with respect to FIG. 4B processes the errors 210 as they are generated by the analysis tool 218, this is not a requirement of the present invention. The error processor 202 may, for example, post-process all of the errors 210 after they have been generated by the analysis tool 218 using a method such as the method 420 to iterate over each of the errors 210.

As described above, software programs such as the analysis tool 218 may generate various messages in addition to error messages. For example, the analysis tool may generate status messages which indicate the status of the analysis (such as messages indicating that a particular stage of the analysis has been completed successfully) and warning messages which provide the circuit designer 116 with information that indicates a potential problem with the circuit model or the analysis but which do not constitute errors (such as parameter values which are potentially out of range).

The errors 210, therefore, may include not only errors but any kind of event generated by the analysis tool 218 or any other component of a computer system. The error processor 202 is, therefore, more generally an event processor. Similarly, the error messages 204 may include not only error messages but any kind of messages generated in response to errors 210, and the error actions 206 may include any kind of actions taken in response to errors 210. Furthermore, the techniques disclosed herein are not limited to use in conjunction with circuit design and analysis tools, but may be implemented more generally in conjunction with any hardware and/or software system which outputs messages to a user.

Although the drawings illustrate various data structures (e.g., the configuration information 208 in FIG. 3A and the error messages 210 in FIG. 5) as having particular logical structures, these are provided merely for purposes of example and do not constitute limitations of the present invention. Rather, alternative data structures for representing equivalent information and for performing equivalent functions will be apparent to these of ordinary skill in the art. For example, the various mappings in the configuration information 208 need not be implemented using distinct mappings for each one of the types and/or priorities. For example, a particular action, output location, and/or counter limit may be mapped to a range of priorities or types rather than to a single priority or type. Furthermore, although various data structures are described as being implementable as text files, this is not a limitation of the present invention. Rather, such data structures may be implemented as binary files, database files, or using any appropriate computer-readable format.

Elements and components described herein may be further divided into additional components or joined together to form fewer components for performing the same functions. For example, although the error processor 202 and the analysis tool 218 are illustrated in FIG. 2A as distinct entities, it should be appreciated that they may be combined or further subdivided.

The techniques described above may be implemented, for example, in hardware, software, firmware, or any combination thereof. The error processor 202 may, for example, be implemented as a computer program. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising steps of:
(A) receiving an indication of an error;
(B) identifying a priority of the error;
(C) determining whether at least one action is associated with the priority of the error;
(D) identifying the at least one action associated with the priority of the error if it is determined that at least one action is associated with the priority of the error; and
(E) performing the at least one action associated with the priority of the error if it is determined that at least one action is associated with the priority of the error.

2. The method of claim 1, wherein the step (A) comprises a step of receiving the error indication from a circuit design analysis tool, and wherein the error indication comprises an indication of an error generated by the circuit design analysis tool when analyzing a circuit design.

3. The method of claim 1, further comprising a step of:
(F) identifying a type of the error; and
wherein the step (B) comprises a step of:
(B)(1) identifying the priority of the error based on the type of the error.

4. The method of claim 3, wherein the step (B)(1) comprises steps of:
(B)(1)(a) identifying a plurality of mappings between a plurality of error types and a plurality of error priorities;
(B)(1)(b) identifying one of the plurality of mappings which maps the type of the error to a mapped error priority; and
(B)(1)(c) identifying the mapped error priority as the priority of the error.

5. The method of claim 3, further comprising steps of:
(G) identifying an identifier of the error;
(H) determining whether an override priority is associated with the identifier of the error; and
wherein the step (B) further comprises a step of:
(B)(2) identifying the override priority as the priority of the error if it is determined that an override priority is associated with the identifier of the error.

6. The method of claim 1, wherein the step (C) comprises a step of determining whether an output action is associated with the priority of the error, wherein the step (D) comprises steps of:
(D)(1) identifying at least one output location associated with the error;
(D)(2) identifying an error message associated with the error; and
wherein the step (E) comprises a step of:
(E)(1) outputting the error message associated with the error to the at least one output location associated with the error only if it is determined that the output action is associated with the priority of the error.

7. The method of claim 6, wherein the error indication comprises a data structure including an indicated error message, and wherein the step (D)(2) comprises a step of identifying the indicated error message as the error message associated with the error.

8. The method of claim 6, wherein the step (D)(1) comprises steps of:
(D)(1)(a) identifying a plurality of mappings between a plurality of error priorities and a plurality of output locations;
(D)(1)(b) identifying one of the plurality of mappings which maps the priority of the error to at least one mapped output location; and
(D)(1)(c) identifying the mapped output location as the at least one output location associated with the error.

9. The method of claim 6, further comprising steps of:
(F) identifying an identifier of the error;
(G) determining whether an output suppression action is associated with the identifier of the error; and
wherein the step (E)(1) comprises a step of outputting the error message associated with the error to the at least one output location associated with the error only if it is determined that the output action is associated with the priority of the error and it is determined that the output suppression action is not associated with the identifier of the error.

10. The method of claim 6, further comprising steps of:
(F) identifying an identifier of the error;
(G) determining whether an output enablement action is associated with the identifier of the error; and
wherein the step (E)(1) comprises a step of outputting the error message associated with the error to the at least one output location associated with the error if it is determined either that the output action is associated with the priority of the error or that the output enablement action is associated with the identifier of the error.

11. The method of claim 1, wherein the step (C) comprises steps of:
(C)(1) identifying a plurality of mappings between a plurality of error priorities and a plurality of error actions;
(C)(2) identifying one of the plurality of mappings corresponding to the priority of the error; and
(C)(3) determining whether the identified mapping maps the priority of the error to at least one action.

12. The method of claim 1, wherein the step (D) comprises steps of:
(D)(1) identifying at least one mapped error action to which the identified mapping maps the priority of the error; and
(D)(2) identifying the at least one mapped error action as the at least one action associated with the priority of the error.

13. The method of claim 1, wherein the step (D) comprises steps of:
(D)(1) identifying an error counter limit associated with the error;
(D)(2) identifying an error counter value associated with the error;
(D)(3) determining whether the error counter value is greater than the error counter limit; and
wherein the step (E) comprises a step of performing the at least one action associated with the priority if it is determined that the error counter value is not greater than the error counter limit.

14. The method of claim 13, further comprising a step of:
(D)(4) incrementing the error counter value.

15. The method of claim 13, wherein the step (D)(1) comprises steps of:
(D)(1)(a) identifying a plurality of mappings between a plurality of error types and a plurality of error counter limits;
(D)(1)(b) identifying one of the plurality of mappings which maps the identified error type to at least one mapped error counter limit; and
(D)(1)(c) identifying the mapped error counter limit as the error counter limit.

16. The method of claim 13, wherein the step (D)(1) comprises steps of:
(D)(1)(a) identifying an identifier of the error;
(D)(1)(b) identifying a mapped error counter limit associated with the identifier of the error; and
(D)(1)(c) identifying the mapped error counter limit as the error counter limit.

17. The method of claim 1, wherein the step (C) comprises a step of determining whether a process termination action is associated with the priority, and wherein the step (E) comprises a step of terminating a process associated with the method if it is determined that the process termination action is associated with the priority.

18. The method of claim 17, wherein the process associated with the method comprises a computer-implemented process performed by a circuit design analysis tool to analysis a circuit design.

19. The method of claim 1, further comprising steps of:
(F) identifying an identifier of the error;
(G) determining whether a suppression action is associated with the identifier of the error; and
wherein the step (E) comprises a step of performing the at least one action associated with the priority of the error if it is determined that at least one action is associated with the priority of the error and it is determined that the suppression action is not associated with the identifier of the error.

20. The method of claim 1, further comprising steps of:
(F) identifying an identifier of the error;
(G) determining whether an enablement action is associated with the identifier of the error; and
wherein the step (E) comprises a step of performing the at least one action associated with the priority of the error if it is determined either that at least one action is associated with the priority of the error or that the enablement action is associated with the identifier of the error.

21. A computer system comprising:
receiving means for receiving an indication of an error;
priority identification means for identifying a priority of the error;
action determination means for determining whether at least one action is associated with the priority of the error;
action identification means for identifying the at least one action associated with the priority of the error if it is determined that at least one action is associated with the priority of the error; and
action performance means for performing the at least one action associated with the priority of the error if it is determined that at least one action is associated with the priority of the error.

22. The system of claim 21, wherein the receiving means comprises means for receiving the error indication from a circuit design analysis tool, and wherein the error indication comprises an indication of an error generated by the circuit design analysis tool when analysis a circuit design.

23. The system of claim 21, further comprising:
type identification means for identifying a type of the error; and
wherein the priority identification means comprises means for identifying the priority of the error based on the type of the error.

24. The system of claim 23, further comprising:
a plurality of mappings between a plurality of error types and a plurality of error priorities; and
wherein the priority identification means further comprises:
means for identifying one of the plurality of mappings which maps the type of the error to a mapped error priority; and
means for identifying the mapped error priority as the priority of the error.

25. The system of claim 23, further comprising:
means for identifying an identifier of the error;
means for determining whether an override priority is associated with the identifier of the error; and
wherein the priority identification means further comprises means for identifying the override priority as the priority of the error if it is determined that an override priority is associated with the identifier of the error.

26. The system of claim 21, wherein the action determination means comprises means for determining whether an output action is associated with the priority of the error, wherein the action identification means comprises:
means for identifying at least one output location associated with the error;
means for identifying an error message associated with the error; and
wherein the action performance means comprises:
means for outputting the error message associated with the error to the at least one output location associated with the error only if it is determined that the output action is associated with the priority of the error.

27. The system of claim 26, wherein the error indication comprises a data structure including an indicated error message, and wherein the action identification means comprises means for identifying the indicated error message as the error message associated with the error.

28. The system of claim 26, further comprising:
a plurality of mappings between a plurality of error priorities and a plurality of output locations; and
wherein the action identification means further comprises:
means for identifying one of the plurality of mappings which maps the priority of the error to at least one mapped output location; and
means for identifying the mapped output location as the at least one output location associated with the error.

29. The system of claim 26, further comprising:
means for identifying an identifier of the error;
means for determining whether an output suppression action is associated with the identifier of the error; and
wherein the means for outputting the error message comprises means for outputting the error message associated with the error to the at least one output location associated with the error only if it is determined that the output action is associated with the priority of the error and it is determined that the output suppression action is not associated with the identifier of the error.

30. The system of claim 26, further comprising:
means for identifying an identifier of the error;
means for determining whether an output enablement action is associated with the identifier of the error; and
wherein the means for outputting the error message comprises means for outputting the error message associated with the error to the at least one output location associated with the error if it is determined either that the output action is associated with the priority of the error or that the output enablement action is associated with the identifier of the error.

31. The system of claim 21, further comprising:
a plurality of mappings between a plurality of error priorities and a plurality of error actions; and
wherein the action determination means comprises:
means for identifying one of the plurality of mappings corresponding to the priority of the error; and
means for determining whether the identified mapping maps the priority of the error to at least one action.

32. The system of claim 31, wherein the action identification means comprises:
means for identifying at least one mapped error action to which the identified mapping maps the priority of the error; and
means for identifying the at least one mapped error action as the at least one action associated with the priority of the error.

33. The system of claim 21, wherein the action identification means comprises:
means for identifying an error counter limit associated with the error;
means for identifying an error counter value associated with the error;
means for determining whether the error counter value is greater than the error counter limit; and
wherein the action performance means comprises means for performing the at least one action associated with the priority if it is determined that the error counter value is not greater than the error counter limit.

34. The system of claim 33, further comprising:
means for incrementing the error counter value.

35. The system of claim 33, further comprising:
a plurality of mappings between a plurality of error types and a plurality of error counter limits; and
wherein the action identification means further comprises:
means for identifying one of the plurality of mappings which maps the identified error type to at least one mapped error counter limit; and
means for identifying the mapped error counter limit as the error counter limit.

36. The system of claim 33, wherein the means for identifying an error counter limit comprises:
means for identifying an identifier of the error;
means for identifying a mapped error counter limit associated with the identifier of the error; and
means for identifying the mapped error counter limit as the error counter limit.

37. The system of claim 21, wherein the action determination means comprises means for determining whether a process termination action is associated with the priority, and wherein the action performance means comprises means for terminating a process associated with the method if it is determined that the process termination action is associated with the priority.

38. The system of claim 37, wherein the process associated with the method comprises a computer-implemented process performed by a circuit design analysis tool to analysis a circuit design.

39. The system of claim 21, further comprising:
means for identifying an identifier of the error;
means for determining whether a suppression action is associated with the identifier of the error; and
wherein the action performance means comprises means for performing the at least one action associated with the priority of the error if it is determined that at least one action is associated with the priority of the error and it is determined that the suppression action is not associated with the identifier of the error.

40. The system of claim 21, further comprising:
means for identifying an identifier of the error;
means for determining whether an enablement action is associated with the identifier of the error; and
wherein the action performance means comprises means for performing the at least one action associated with the priority of the error if it is determined either that at least one action is associated with the priority of the error or that the enablement action is associated with the identifier of the error.

41. A computer-implemented method comprising steps of:
(A) receiving an indication of an event associated with a message suitable for output to a user through an output device;
(B) identifying a priority of the event;
(C) determining whether the message should be output to the user through the output device based on the priority of the event; and
(D) outputting the message to the user through the output device if it is determined that the message should be output to the user through the output device.

42. The method of claim 41, wherein the step (A) comprises a step of receiving the event indication from a circuit design analysis tool, and wherein the event indication comprises an indication of an event generated by the circuit design analysis tool when analyzing a circuit design.

43. The method of claim 41, further comprising a step of:
(E) identifying a type of the event; and
wherein the step (B) comprises a step of:
(B)(1) identifying the priority of the event based on the type of the event.

44. The method of claim 43, wherein the step (B)(1) comprises steps of:
(B)(1)(a) identifying a plurality of mappings between a plurality of event types and a plurality of event priorities;
(B)(1)(b) identifying one of the plurality of mappings which maps the type of the event to a mapped event priority; and
(B)(1)(c) identifying the mapped event priority as the priority of the event.

45. The method of claim 43, further comprising steps of:
(F) identifying an identifier of the error;
(G) determining whether an override priority is associated with the identifier of the error; and
wherein the step (B) further comprises a step of:
(B)(2) identifying the override priority as the priority of the error if it is determined that an override priority is associated with the identifier of the error.

46. The method of claim 41, wherein the step (C) comprises steps of:
(C)(1) identifying a plurality of mappings between a plurality of event priorities and a plurality of output locations;
(C)(2) identifying one of the plurality of mappings which corresponds to the priority of the event; and
(C)(3) determining that the message should be output to the user through the output device if the identified one of the plurality of mappings maps the priority of the event to an output location.

47. A computer system comprising:
receiving means for receiving an indication of an event associated with a message suitable for output to a user through an output device;
priority identification means for identifying a priority of the event;
output determination means for determining whether the message should be output to the user through the output device based on the priority of the event; and
output means for outputting the message to the user through the output device if it is determined that the message should be output to the user through the output device.

48. The system of claim 47, wherein the receiving means comprises means for receiving the event indication from a circuit design analysis tool, and wherein the event indication comprises an indication of an event generated by the circuit design analysis tool when analyzing a circuit design.

49. The system of claim 47, further comprising:
event identification means for identifying a type of the event; and
wherein the priority identification means comprises:
means for identifying the priority of the event based on the type of the event.

50. The system of claim 49, further comprising:
a plurality of mappings between a plurality of event types and a plurality of event priorities; and
wherein the priority identification means further comprises:
means for identifying one of the plurality of mappings which maps the type of the event to a mapped event priority; and
means for identifying the mapped event priority as the priority of the event.

51. The system of claim 49, further comprising:
means for identifying an identifier of the error;
means for determining whether an override priority is associated with the identifier of the error; and
wherein the priority identification means further comprises means for identifying the override priority as the priority of the error if it is determined that an override priority is associated with the identifier of the error.

52. The system of claim 47, wherein the output determination means comprises:
means for identifying a plurality of mappings between a plurality of event priorities and a plurality of output locations;
means for identifying one of the plurality of mappings which corresponds to the priority of the event; and
means for determining that the message should be output to the user through the output device if the identified one of the plurality of mappings maps the priority of the event to an output location.

53. A computer system comprising:
a plurality of priority-action mappings between a plurality of event priorities and a plurality of event actions; and
a software program comprising computer program instructions for:
receiving an indication of an event associated with a message suitable for output to an output location;
identifying a priority of the event;
determining whether an action is associated with the event based on the plurality of priority-action mappings;
identifying the action associated with the event if it is determined that an action is associated with the event; and
performing the action associated with the event if it is determined that an action is associated with the event;
wherein the plurality of priority-action mappings do not comprise a part of the computer program instructions.

54. The system of claim 53, wherein the event indication comprises an indication of an event generated by a circuit design analysis tool when analyzing a circuit design.

55. The system of claim 53, further comprising:
a plurality of type-priority mappings between a plurality of event types and a plurality of event priorities, wherein the plurality of type-priority mappings do not comprise a part of the computer program instructions; and
wherein the software program further comprises computer program instructions for:
receiving a type of the error;
identifying one of the plurality of type-priority mappings which maps the type of the error to a mapped error priority; and
identifying the mapped error priority as the priority of the error.

56. The system of claim 53, further comprising:
a plurality of priority-location mappings between the plurality of event priorities and a plurality of output locations, wherein the plurality of priority-location mappings do not comprise a part of the computer program instructions; and
wherein the software program further comprises computer program instructions for:
identifying one of the plurality of priority-location mappings which maps the priority of the error to a mapped output location; and
outputting the message to the mapped output location if it is determined that an action is associated with the event.

57. The system of claim 56, further comprising:
a plurality of type-limit mappings between the plurality of event types and a plurality of event counter limits, wherein the plurality of type-limit mappings do not comprise a part of the computer program instructions; and
wherein the software program further comprises computer program instructions for:
identifying one of the plurality of type-limit mappings which maps the type of the event to a mapped counter limit; and
identifying the mapped counter limit as a counter limited associated with the event.

58. The system of claim 53, further comprising:
a plurality of priority-action mappings between the plurality of event priorities and a plurality of event actions, wherein the plurality of priority-action mappings do not comprise a part of the computer program instructions; and
wherein the software program further comprises computer program instructions for:
identifying one of the plurality of priority-action mappings which maps the priority of the event to a mapped event action;
identifying the mapped event action as the action associated with the event.
